(19) United States
(12) Patent Application Publication
(10) Pub. No.: US 2006/0132995 A1
(43) Pub. Date: Jun. 22, 2006

(54) Method for whole-chip electrostatic-discharge protection

(75) Inventor: Chu-Sheng Lee, Tainan City (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/013,351

(22) Filed: Dec. 17, 2004

(51) Int. Cl. H02H 9/00

(52) U.S. Cl. 361/56

(57) ABSTRACT

The present invention relates to a method of whole-chip electrostatic discharge protection, wherein the chip has a first metallic layer and a second metallic layer, and each surrounds the chip along the trail keeping an appropriate spacing away from the perimeter of the chip separately, and in contrast to the first type semiconductor substrate, a second type semiconductor well is formed below the first metallic layer. The second type semiconductor well, which surrounds the chip along the trail keeping an appropriate spacing away from the perimeter of the chip, can function as a large capacitor to store the discharged electricity. Thereby, the electrostatic discharge protection of the whole chip can be promoted with no increasing chip area needed and without changing the original design and manufacture process of IC.

### FIELD OF THE INVENTION

The present invention relates to a whole-chip electrostatic-discharge protective method, which needs neither to change the original design or manufacture process nor to increase the area of the integrated circuit (IC).

### BACKGROUND OF THE INVENTION

Evolving with the mass-product process, the dimension of IC's element has been reduced to a deep-submicron scale in order to promote the performance and the operating speed of IC and decrease the manufacture cost of each IC chip; however, with the reduced dimension, some reliability problems appear, such electrostatic discharge (ESD).

According to its generating and discharging ways, ESD is divided into four categories: (1) Human-Body Model (HBM), (2) Machine Model (MM), (3) Charged-Device Model (CDM), (4) Field-Induced Model (FIM).

As the accumulated electrostatic charge can be positive or negative, the electrostatic-discharge test can be either a positive or a negative one for the same IC pin. For each I/O pin, the electrostatic-discharge tests for HBM or MM of IC's ESD have the following four sets of combinations: (1) PS-mode: VSS pin grounded, I/O pin discharging to VSS pin in positive voltage (I/O pin positively stressing on VSS pin), with VDD and the other pins floating, (2) NS-mode: VSS grounded, I/O pin discharging to VSS pin in negative voltage (I/O pin negatively stressing on VSS pin), with VDD and the other pins floating, (3) PD-mode: VDD grounded, I/O pin discharging to VDD pin in positive voltage (I/O pin positively stressing on VDD pin), with VSS and the other pins floating, (4) ND-mode: VDD grounded, I/O pin discharging to VDD pin in negative voltage (I/O pin negatively stressing on VDD pin), with VSS and the other pins floating.

The conventional ESD protection method is that an ESD protection circuit is installed between a solder pad and the path integrating most I/O of the semiconductor device; for example, the U.S. Pat. No. 5,514,892 proposed an ESD protection circuit, wherein a diode is formed below the lead's solder pad within a semiconductor's well.

As the electrostatic charge is far from less in the general usage environment of the product, the damage of CMOS IC induced by ESD is further more serious. For example, when the channel width of a general output buffer element is assigned to be 300 μm, the NMOS element fabricated with the traditional 2-micron technology can endure more than 3 KV in HBM; However, the same element fabricated with 1-micron process plus LDD technology can endure less than 2 KV in HBM, and the same element fabricated with 1-micron process plus LDD and Silicide technology can endure only about 1 KV in HBM. It is to be known thereby that owing to the progress of technology, even the element size unchanged, the ESD preventability of the element still slides down significantly. Even further enlarging the element size, the ESD preventability is not supposed to be promoted proportionally. When the element size is enlarged, the layout area will be enlarged correspondingly and the whole-chip area will be increased. However, the endurability of ESD will descend seriously, and it is a tough problem that many products of deep-submicron CMOS IC have encountered.

### SUMMARY OF THE INVENTION

The primary objective of the present invention is to promote the whole-chip ESD protection capability without increasing the chip area in order that the input pad and output pad can possess the protection capability against ESD of PS, NS, PD and ND mode.

Another objective of the present invention is to enable the method of the present invention to apply to the ESD protection-enhancing design of any kind of chip without changing the design and manufacture process of IC.

The present invention is a method for whole-chip ESD protection, wherein a first and a second metallic layer surround the chip along the trails paralleling the perimeter of the chip and separately keeping an appropriate spacing away from the perimeter of the chip, and in contrast to the first type semiconductor substrate, a second type semiconductor well is formed below the first metallic layer. The second type semiconductor well, which surrounds the chip along the trail keeping an appropriate spacing away from the perimeter of the chip, can function as a large capacitor to store the discharged electricity.

As the above-mentioned well is formed below the inner rim of the chip, which is an unexploited portion of the chip, it will not influence the chip area, which is extremely cared about now.

### BRIEF DESCRIPTION OF THE DRAWINGS

FIG. 1 is a schematic diagram of the layout of the present invention.

FIG. 2 is a schematic sectional diagram of one preferred embodiment of the present invention.

FIG. 3 is a schematic sectional diagram of another preferred embodiment of the present invention.

### DETAILED DESCRIPTION OF THE PREFERRED EMBODIMENTS

The detailed description of the present invention will be stated below in conjunction with the accompanying drawings.

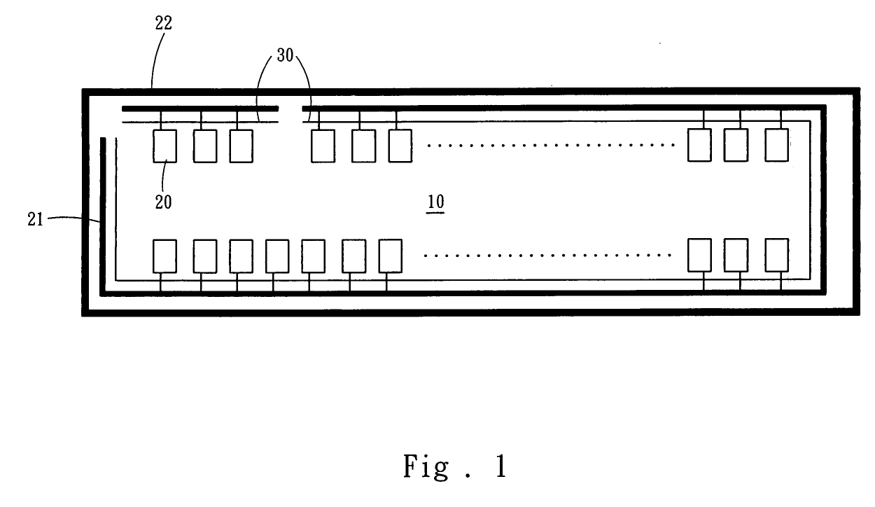

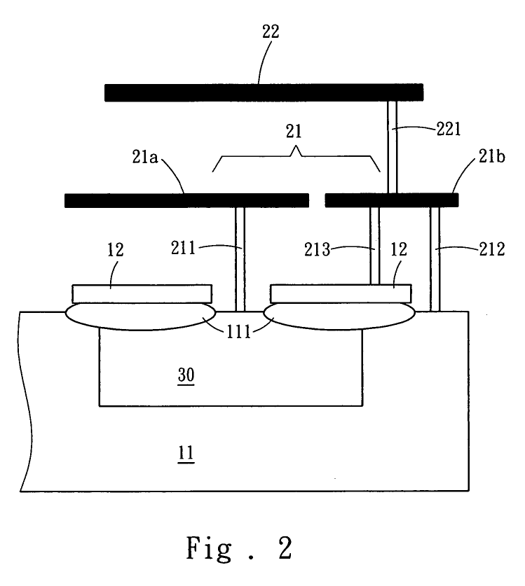

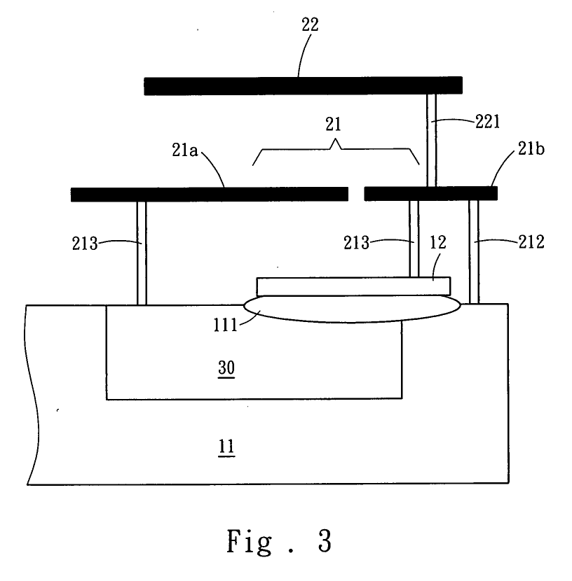

Refer simultaneously to FIG. 1, FIG. 2 and FIG. 3 schematic sectional diagrams of the preferred embodiments of the present invention. As shown in FIG. 1, a first metallic layer 21 surrounds the chip 10 along the trail keeping an appropriate spacing away from the perimeter of the chip 10, wherein the first metallic layer 21 is coupled to a high voltage VDD; a grounded second metallic layer 22 exists above the metallic layer 21, and a plurality of solder pads 20 are coupled to the first metallic layer 21. As shown in FIG. 2 and FIG. 3, the characteristic of the present invention is that the first metallic layer 21 is divided into a first metallic layer one 21a and a neighboring first metallic layer two 21b, and in contrast to the first type semiconductor substrate 11, such as a P-substrate, a second type semiconductor well 30, such as a N-well, is formed below the first metal layer one 21a, and via a contact bolt 211 below the first metallic layer one 21a, the solder pad 20 is interconnected with the second type semiconductor well 30.

Separately via a contact bolt 221 and a contact bolt 212, the first metallic layer two 21b is interconnected with the second metallic layer 22 and the first type semiconductor substrate 11 in a series way, and thereby, all of those are commonly grounded, and thereby, the electrostatic charge coupled to the series path can be taken away.

The second type semiconductor well 30, which surrounds the chip 10 along the trail keeping an appropriate spacing away from the perimeter of the chip 10, can function as a large capacitor to store the discharged electricity. A pair of oxide layers 111 parallel to each other, as shown in FIG. 2, or a single oxide layer 111, as shown in FIG. 3 is formed above the second type semiconductor well 30, and the well 30 is formed to be a well shape structure below the oxide layer 111. A first type semiconductor polysilicon 12 is formed above the oxide layer 111, and via a contact bolt 213, the first metallic layer two 21b is interconnected with the first type semiconductor polysilicon 12. As mentioned above, via the contact bolt 221, the first metallic layer two 21b is interconnected with the second metallic layer 22, and now via the contact bolt 213, the first metallic layer two 21b is further interconnected with the first type semiconductor polysilicon 12, and thereby, all of those are interconnected in series and commonly grounded, and thereby, the electrostatic charge coupled to the series path can be taken away.

The second type semiconductor well 30 is interconnected with the first metallic layer one 21a via a contact bolt 211 below the first metallic layer one 21a. As the first metallic layer one 21a is in a high voltage VDD, the second type semiconductor well 30 is also in high voltage; as mentioned above, the first type semiconductor polysilicon 12 is grounded and in a low voltage GND; thus, a large capacitor is formed between the first type semiconductor polysilicon 12 and the second type semiconductor well 30.

Similarly, a capacitor is also formed between the first type semiconductor polysilicon 12 (in low voltage) and the first metallic layer one 21a (in high voltage), and a capacitor is also formed between the second metallic layer 22 (in low voltage) and the first metallic layer one 21a (in high voltage). Those three capacitors are coupled in parallel to form a large capacitor, and via the aforementioned series coupling and common grounding, the electrostatic charge coupled to the series path can be taken away.

The configuration of the second type semiconductor well 30 imitates that of the first metallic layer 21, i.e., according to the IC's circuitry routing design, the second type semiconductor well 30 can either be continuous and surrounding the chip 10 as the first metallic layer 21 does, or be segmented as the first metallic layer 21 is.

A 15000 μm*1500 μm of LCD's driver chip is exemplified to show the efficacy of the present invention, wherein if the width of the second type semiconductor well 30 is 20 μm, a 250 Kμm² of capacitor area will be added. Such a large capacitor area comes from the capacitor between the second type semiconductor well 30 (in high voltage) and the first type semiconductor polysilicon 12 (in low voltage), and the capacitor between the first metallic layer one 21a (in high voltage) and the second metallic layer 22 (in low voltage). It will increase about 131 pF of capacitance to store the electricity generated by ESD.

It is to be noted from those discussed above that as the method of the present invention utilizes the lower portion of the unexploited internal rim bordering the chip's perimeter, the whole-chip ESD protection is promoted with no increasing chip area needed, so that the input pad and output pad have the protection capability against those four modes of ESD, i.e. PS, NS, PD and ND mode; further, as the second type semiconductor well 30, the oxide layer 111, and the first type semiconductor polysilicon 12 are originally included in a general manufacture process of IC, the method of the present invention can apply to the ESD protection-enhancing design of any kind of chip without changing the design and manufacture process of IC.

Those described above are only the preferred embodiments of the present invention, and not intended to limit the scope of the present invention. Any equivalent modification and variation according to the claims of the present invention is to be included within the scope of the present invention.

What is claimed is:

1. A method of whole-chip electrostatic discharge protection applying to a chip, comprising,
a first metallic layer that surrounds said chip along the trail keeping an appropriate spacing away from the perimeter of said chip and is coupled to a high voltage VDD;
a second metallic layer that is disposed above said first metallic layer and grounded to GND; and
a plurality of solder pads that are coupled to said first metallic layer;
wherein
said first metallic layer is divided into a first metallic layer one and a first metallic layer two;
a second type semiconductor well is formed below said first metallic layer one, in contrast to the first type semiconductor substrate;
an oxide layer is formed above said second type semiconductor well;
a first type semiconductor polysilicon is formed above said oxide layer;
said first metallic layer two is interconnected with said first type semiconductor polysilicon via a contact bolt;
said first metallic layer one is interconnected with said second type semiconductor well via a contact bolt below said first metallic layer one; and
said first metallic layer two is sequentially interconnected with said second metallic layer and said first type semiconductor substrate via contact bolts;
thereby, a large capacitor is formed to store the electrostatic charge via paralleling the capacitor between said second type semiconductor well and said first type semiconductor polysilicon, and the capacitor between said first metallic layer one and said second metallic layer.

2. The method of whole-chip electrostatic discharge protection according to claim 1, wherein said second type semiconductor well is interconnected with said first metallic layer one via a contact bolt, and in the same high voltage VDD as said first metallic layer one.

3. The method of whole-chip electrostatic discharge protection according to claim 1, wherein said first type semiconductor polysilicon and said first metallic layer two are coupled to said second metallic layer, and in the same low voltage as said second metallic layer.

4. The method of whole-chip electrostatic discharge protection according to claim 1, wherein the configuration of said second type semiconductor well imitates the routing of said first metallic layer.
